(19) United States
(12) Patent Application Publication
(10) Pub. No.: US 2004/0050930 A1
(43) Pub. Date: Mar. 18, 2004

(54) Smart card with onboard authentication facility

(76) Inventor: Bernard Rowe, Kew Gardens, NY (US)

Correspondence Address: OSTROLENK FABER GERB & SOFFEN, 1180 AVENUE OF THE AMERICAS, NEW YORK, NY, 100368403

(21) Appl. No.: 10/246,017

(22) Filed: Sep. 17, 2002

(51) Int. Cl. G06K 5/00; G06K 19/06

(52) U.S. Cl. 235/380; 235/492

(57) ABSTRACT

A self-authenticating smart card that authenticates the bearer thereof by verifying biometric personal data of the bearer, without storing reference biometric data at remote databases or outside the smart card and without transmitting the personal data through private or public data channels. The smart card can be implemented as a smart card combined with a conventional magnetic strip to permit use at establishments that are not configured to handle smart cards.

### BACKGROUND OF THE INVENTION

The present invention is generally directed to smart cards and, more particularly, to smart cards that self-authenticate the bearers thereof, by verifying biometric personal data of the bearer, without resorting to reference biometric data stored at remote databases or outside the smart card or transmitting the same through private or public data channels.

Smart cards are cards made from plastic or other materials and further comprise electronic circuitry that deliver intelligent processing capability. Typically, smart cards may be programmed to perform a wide variety of functions, such that the smart card may act as a credit card, a door opener/closer key, a store of medical information, a passport, a driver's license, an I.D. card, and the like. Thus, a single smart card has the potential of replacing many of the items that people carry and use in their day-to-day lives.

A large body of patent, as well as non-patent literature has developed and been published in relation to smart cards. In particular, the present invention relates to and improves upon the technology described in U.S. Pat. Nos. 6,325,285; 6,311,272; and 6,182,892, the contents of which are incorporated by reference herein.

As described in the aforementioned U.S. Pat. No 6,325,285, it has been suggested to combine the use of smart cards with a biometric test, in order to confirm that a person using the card is, in fact, an authorized user, such as the card owner. The technology exists that enables comparing the fingerprint of an individual presenting a smart card to a stored fingerprint in order to ensure that the person presenting the card is authorized to use the card. But the fear and uneasiness persists on the part of many individuals that their personal information, such as their fingerprints, signature, names and birth dates of close relatives and the like is likely to be misused if it is permitted to be stored in data records over which these individuals do not have total control.

The prior art teaches and suggests techniques, the objective of which is to provide a system and method that confirms the identity of an individual presenting a smart card using biometric data, which does not require any of the individual's biometric information to be collected or stored by a remote reader or device or stored in central data repositories which are not immediately accessible to and under the individual's control. Nonetheless, it is still so under the most advanced techniques known to the instant inventor, that smart cards are used in conjunction with local card readers located at business establishments and/or government agencies that require the cards to be interfaced to such readers and the personal information is accessed by those readers and/or displayed thereon so that it can be tapped, copies or accessed, much to the discomfort and unease of the bearers of the smart cards.

### SUMMARY OF THE INVENTION

It is therefore an object of the present invention to provide a smart card that confirms the identity of an individual presenting the smart card using various biometrics or personal information, but which does not require the transfer or the display of the personal biometric or other personal information, however temporarily, on any device other than on or within the four corners of the smart card.

A further object of the present invention is to provide a smart card that is economic to produce and easy to use.

The foregoing and other objects of the invention are realized in accordance with the present invention with a smart card that comprises a housing defining an interior and having an exterior surface with electronic circuitry housed in the interior and with a memory for storing personal data identifying an authorized bearer of the smart card. A sensor is provided that is able to detect a personal characteristic of the authorized bearer to develop information that is compared with the pre-stored personal data to authenticate the smart card. The smart card can be provided as an exclusively electronically operable smart card or as a smart card operating in conjunction with a magnetic strip to enable usage in establishments that do not possess equipment for handling smart cards.

The smart card can be configured as a card that can function as one or more of: a credit card; a debit card; driver's license; a personal identification card; a travel document; an electronic key; and/or a club membership card.

Other features and advantages of the present invention will become apparent from the following description of the invention which refers to the accompanying drawings.

### BRIEF DESCRIPTION OF THE DRAWINGS

FIG. 1 is a diagram of a first preferred embodiment of the smart card of the present invention.

FIG. 2 is a schematic of electronic components of the smart card of the present invention.

FIG. 3 is a first flowchart depicting certain steps/processes that are incorporated in the smart card of the present invention.

FIG. 4 is a second flowchart depicting certain steps/processes that are incorporated in the smart card of the present invention.

FIG. 5 is a third flowchart depicting certain steps/processes that are incorporated in the smart card of the present invention.

FIG. 6 is a fourth flowchart depicting certain steps/processes that are incorporated in the smart card of the present invention.

FIG. 6a is a fifth flowchart depicting certain steps/processes that are incorporated in the smart card of the present invention.

FIG. 7 is a diagram depicting a second preferred embodiment of the smart card of the present invention.

FIG. 8 is a diagram depicting an interface to the smart card of the present invention.

FIG. 9 is a block diagram of an access control and personnel tracking system using the smart card of the present invention.

FIG. 10 is a software block diagram associated with a subsystem of the system of FIG. 9.

FIG. 11 is a further software block diagram for the smart card.

### DETAILED DESCRIPTION OF PREFERRED EMBODIMENTS OF THE INVENTION

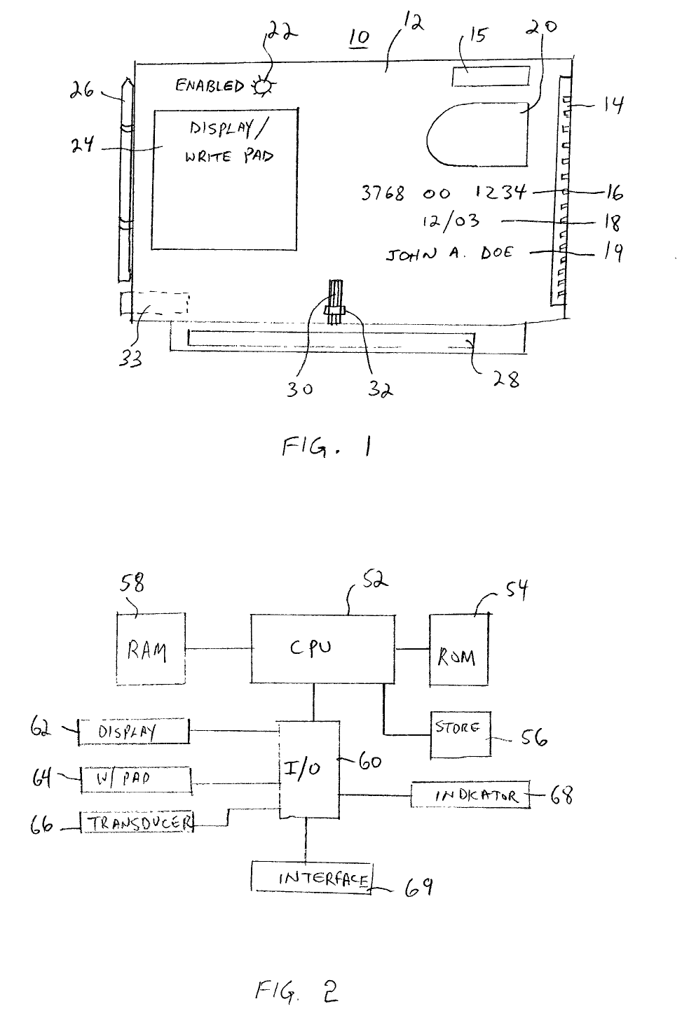

With reference to the drawings, FIG. 1 diagrammatically illustrates a smart car 10 having a generally rectangularly-shaped body 12 with internally housed electronics, for example, a shown in FIG. 2, and having externally accessible biometric transducers, visual indicators, and other sensory and interface components.

More specifically, the smart card 10 may include a visually perceivable, e.g., an embossed, card serial number 16, an expiration date 18, and the name of the authorized smart card bearer 19. It may further show the name of the issuing authority, e.g., American Express, or of several issuing authorities in the case where the card serves as a multicard credit card of several different card authorizers. It may also indicate on its face other designations, such as where the card serves as a driver's license, credit/debit card, passport, etc.

In conventional manner, the smart card 10 further includes electronic coupling facilities for interfacing the smart card to a reader or to other communication equipment and such facilities may be in a form of electrical contacts 14 which may be located on one edge of the smart card 10, or elsewhere thereon. Alternatively or in addition, the card includes an infrared interface 15 for wireless communications or other known or to be developed interface facilities. An LCD display and write pad 24 is available for the display of messages or for the inputting of information that can be written on the write pad, including by means of an included stylus 26.

The biometric transducer/sensor 20 is provided in order to allow the smart card 10 to read biometric information. This facility may be a fingerprint reader or an imaging device for reading the pattern of a human iris, or even a mini chemical laboratory that is capable of analyzing a person's DNA sample or a voice recognition system or, indeed, any device that is capable of reading and/or analyzing biometric information of the human bearer of the smart card 10.

In accordance with the invention, the smart card is enabled through its bearer's interaction with the transducer/sensor 20, as by placing a thumb thereon to allow the internal electronics of the card to process the biometrics and ascertain that the authorized bearer has enabled the card. Thereafter, the electronics turn on an indicator or an enable light 22 for a short time period, to indicate to a person or business to whom the smart card 10 is presented, that the bearer is indeed the rightful owner of the smart card. Alternatively, instead of providing the enable light 22, the function thereof can be produced by a suitable indication on the LCD display 24, e.g., the words: CARD VERIFIED. Still further, the authorization can be in the form of the appearance of the authorized card bearer.

In accordance with a further concept of the invention, the smart card 10 incorporates a conventional magnetic strip 28 that, optionally, can be retracted into an internal space within the body of the smart card 10 by operating a pull button 32 which is mechanically coupled to the stripe and which can be pushed up in the slot 30 to conceal the magnetic stripe. With this expedient, a person may identify herself to a business establishment that does not have the equipment to handle smart card transactions, and thereafter use the conventional magnetic card reader to effectuate a commercial transaction. This feature is intended to ease the transition of industry to smart cards.

With reference to FIG. 2, the internally-provided electronics of the smart card 10 may include a general purpose CPU 52 that interfaces with a non-alterable ROM memory 54, a read/write memory in the form of a RAM 58, a memory storage 56, as well as an input/output (I/O) interface 60 that provides the CPU access to a display circuit 62, a writing pad 64, a transducer 66, an indicator 68 and a general communication interface 69.

The present inventor perceives the smart card of the present invention to be distinguishable over prior smart cards in a variety of ways, including in that the bearer of the card can be positively identified through the smart card without the smart card having to be coupled to any other electronic or reading device and without transmitting to another electronic facility or third party other than within the four corners of the card, any personal or sensitive information. That is, simply by placing a thumb over the sensor 20, the internal electronics reads the fingerprint and verifies it against a reference fingerprint, thereafter turning on the enable light 22 to indicate that the cardbearer is the owner of the particular smart card 10. Further, once the card is enabled—for a minute, or at most a few minutes to complete a given transaction—a personal attribute of the card bearer can be displayed on the LCD display 24. This may include the signature of the bearer, or her likeness, or a description of her appearance, e.g., height, hair color, complexion, etc. While the signature is being displayed, the card bearer may sign a credit slip or the like, enabling the store clerk to compare the signature on the LCD display with the signature just tendered by the bearer. Similarly, the store clerk, or Customs officer, may compare the photo on the LCD display with the likeness of the bearer in front of him. In this manner, a person can reliably identify himself or herself to any authority or business establishment and the like, through the smart card of the present invention, without any concern that personal information, such as his photo or signature or other personal information will be read by or stored in a facility that that person is not comfortable with.

In accordance with a further concept of the invention, once the relationship between the particular smart card and the bearer has been verified, the card can be interfaced through its interface facility, such as via the connector 14, or the infrared port 15, to a reader device, in order to verify the card itself, independent of its bearer. The card is designed so as not to transmit any of the personal information to the reader to which it is interfaced. Rather, the card sends encrypted and other distinguishing information that indicate to the reader, which communicates with the central authority that issued the smart card 10 that the card is, in fact, a valid card issued by the particular issuing institution. Thereby, the smart card of the present invention is effective in both assuring the business establishment to whom it is presented, that it is an authentic card, and by independently verifying that the bearer is the rightful bearer thereof, which indicates that the card was not stolen or forged or otherwise tampered with.

The smart card of the present invention can serve as any of a variety of instruments, such as a credit card, passport, a driver's license, or as an access key to doors, computer equipment, and other facilities and the like. Regardless of how it is configured functionally, the highly personal and critical details remain inaccessible to any reading device and are not communicated over public communication networks, reducing the risk of misuse when falling into the wrong hands. The software facilities within the smart card enable the recording within the memory 56 in the card of various transactional information, e.g., where the card was used and related information. For example, a passport, once activated, could show authorities the countries a person has visited, etc., a credit card could record a transactional history, etc.

Optionally, the length of time that the confirmation signal, which may be the light 22, stays switched on, is programmable, including via inputs entered through the write pad 24, using the stylus 26 or by other means. The circuitry of the smart card 10 may be powered by a variety of means, including battery, solar energy, kinetic energy, light operated panel and the like.

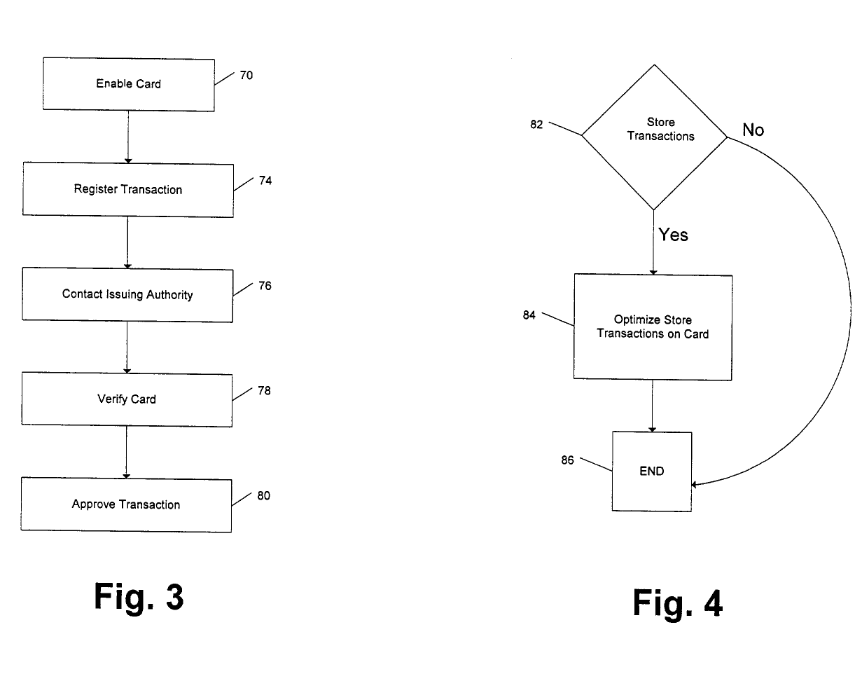

Further aspects of the functionality, methodology and various features and processing steps associated with the smart card 10 of the present invention are elucidated by reference to the flowcharts commencing with FIG. 3 which illustrates a first step 70 that concerns enabling the smart card 10, as by a cardholder placing his thumb on the transducer 20, resulting in enablement of the card. Thereafter, a clerk in a business establishment registers a transaction 74 and proceeds to step 76 which comprises the process of contacting the card issuer, for example, by interfacing the smart card 10 to a card reader interface 140, which initiates communication over the telephone, as illustrated in FIG. 8. Upon receiving information from the smart card 10, the card issuer reads from the card various information and/or codes which indicate to the issuing authority that the communicating card is authentic. It is important to note that the transmitted information need not contain any personal information of the cardholder. Rather, it is intended that the verification information consist of encrypted data that is created at a time that the smart card 10 is issued to the holder. This data may be constituted as a composite card “signature” data that incorporates in its overall information content the cardholder's personal information, as well as various codes known only to the card issuer at the time that the card creation takes place.

Optionally, the transmitted codes are dynamically constructed as composite codes that change over time, depending upon current and/or prior transaction data. This can be effected, for example, by the card taking a checksum of digital data representing the personal information and that checksum value may be used as a scaler or encryption code which is used with other information that is only known to the card issuer, so that the composite data indicates that the card is authentic. The card identification code may incorporate information that includes the original time when the first code was created. Therefore, even a person associated with the issuing authority who may know of or have gotten hold of the internal software, would not be able to recreate the card, because the code being transmitted would not be correct if the personal information was altered, or if the information that a card issuer has embedded on the card has been tampered with.

After the authenticity of the card itself has been verified, an indication thereof may be provided and an approval for proceeding with the transaction is sent to the vendor that presents the card, as indicated by step 80.

In accordance with an option of the present invention and as indicated in FIG. 4, each time a transaction is effected, the decisional software process 82 queries whether the information about the specific transaction should be stored on the card. If the answer is no, the process is aborted at step 86. Otherwise, the process proceeds to store particulars about the specific transaction, for example, the type of purchase, the price of the purchase and the date thereof, which data is stored within the storage memory 56 on the smart card 10, as indicated at step 84.

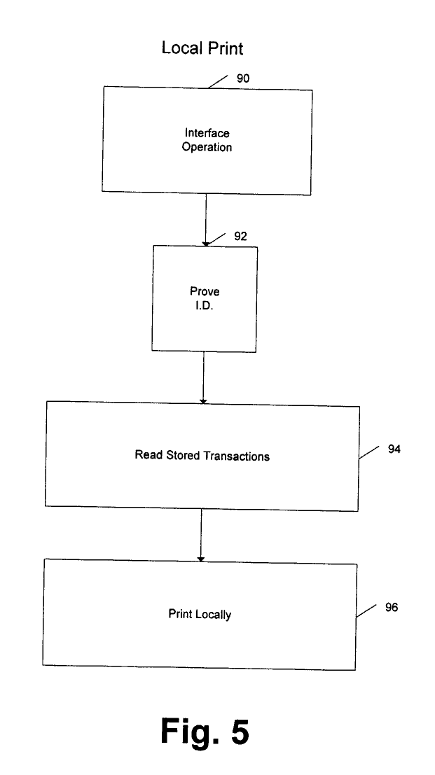

The process illustrated in the flowchart of FIG. 5, allows the cardholder to locally print a record of transactions stored on the smart card 10. To this end, process step 90 involves physically (or wirelessly) connecting the smart card 10 to a card reader interface 140 which has an output 143 in the form of a connector or the like, that permits it to be connected to the user's personal computer (PC) (not shown). Software that has been preloaded in the PC allows the contents of the transactions stored in the storage 56 to be printed or searched or catalogued or organized for various purposes (including preparation of end of year income tax returns and the like). Once the desired information has been collected it can be printed locally, as indicated at step 96, through the printer connected to the PC (not shown) or through a printer 141 that is provided as a component of the card reader interface 140.

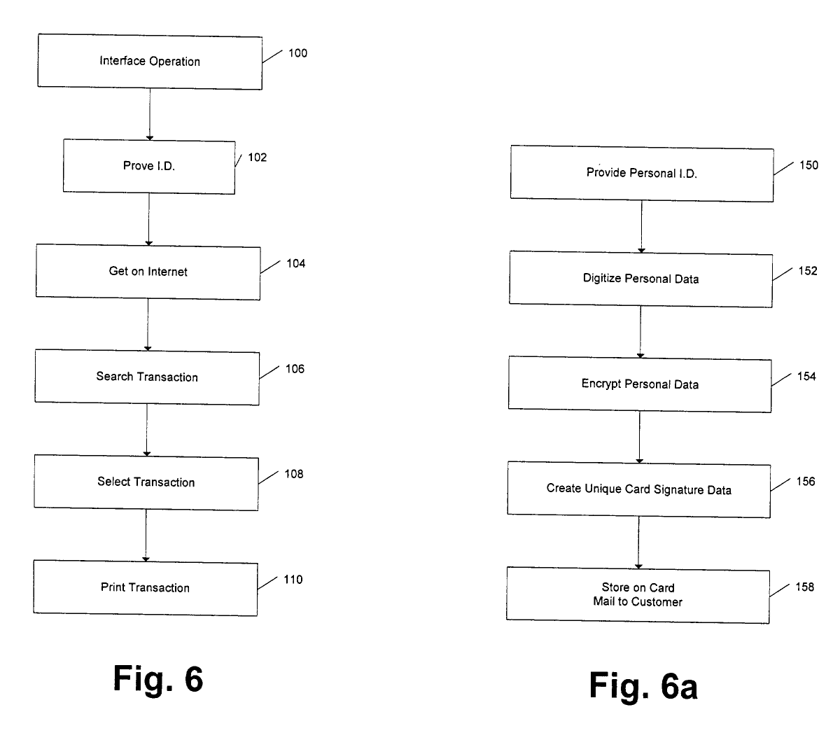

The ability to interface with the card issuer or to query the contents of various transactions that have been stored on the card can also be effected through an Internet-based communication link, as indicated in FIG. 6. Step 100 involves the interfacing operation, such as by using the hardware indicated in FIG. 8. Once a connection has been made to the card issuer, verification of the user's I.D. is attended to through a series of steps that include placing one's thumb on the transducer 20, to create a code word that is transmitted to the card issuer (without communicating any personal information). Alternatively, these steps may involve only the step of communicating that information to the local software resident in one's PC to prevent other people within the same household or within the same organization from using the card 10. Step 104 involves the actual signing on onto the Internet and establishing a communication link to the card issuer. Once the communication has been established, step 106 permits the user to either search or view or select various transactions stored on the card, with a final selection for printing purposes being effected at step 108 and the actual contents being transmitted to the local PC for printing, as indicated at step 110.

The flowchart of FIG. 6a, indicates various process steps that are effected by the card issuer at the time that the card is created. The process commences at step 150 involving the smart card holder providing to the issuer, personal information, for example, in the form of a photo of the person's face, or a facsimile of the signature or samples of DNA or the like. That information which is presented in analog form is appropriately scanned or analyzed and subsequently digitized to create digitized personal data at step 152. The digitized information is then used to create a checksum “signature” of the personal data, for example, by adding up different sections of the data to create checksum values, or by selecting certain data words from the entire database, comprising the digitized personal data as key words that are used for encryption of other information, as indicated in step 154. The ultimate unique codes that are stored on the card are created by taking information such as the name of the person, the date of issuance and other information and encrypting the same with the data derived from the digitized personal data. That data is stored as an identifying code on the card itself, as indicated at step 158. In this form, the card is then mailed or otherwise provided to the end user, together with a certification in the form of an assurance that the personal information that has been supplied by the end user has been destroyed, with the issuing authority or agency retaining no information that would allow recreating the original information. In other words, the card holder receives the assurance that the card issuer maintains no records, either physical or electronic, from which the personal data is retrievable.

The process of the verifying the uniqueness and authenticity of a particular card, includes commanding the card reader to which the smart card is coupled to transmit the unique code to identify the card.

Alternatively, authentication of the smart card can be in the form of instructions to the card to return the data contents of specific or random locations in the memory, the corresponding data of which have been saved by the card issuing agency to compare to the originally stored data to thus ensure that no alterations were made to the card since its issuance.

The device 33 (FIG. 1) is another optional expedient of the invention in the form of a removable memory card, similar to those provided on digital cameras that can be used to store data or in the form of a control card mailed to the card owner yearly to validate and renew the card at least once a year to further enhance the security of the card against forgeries.

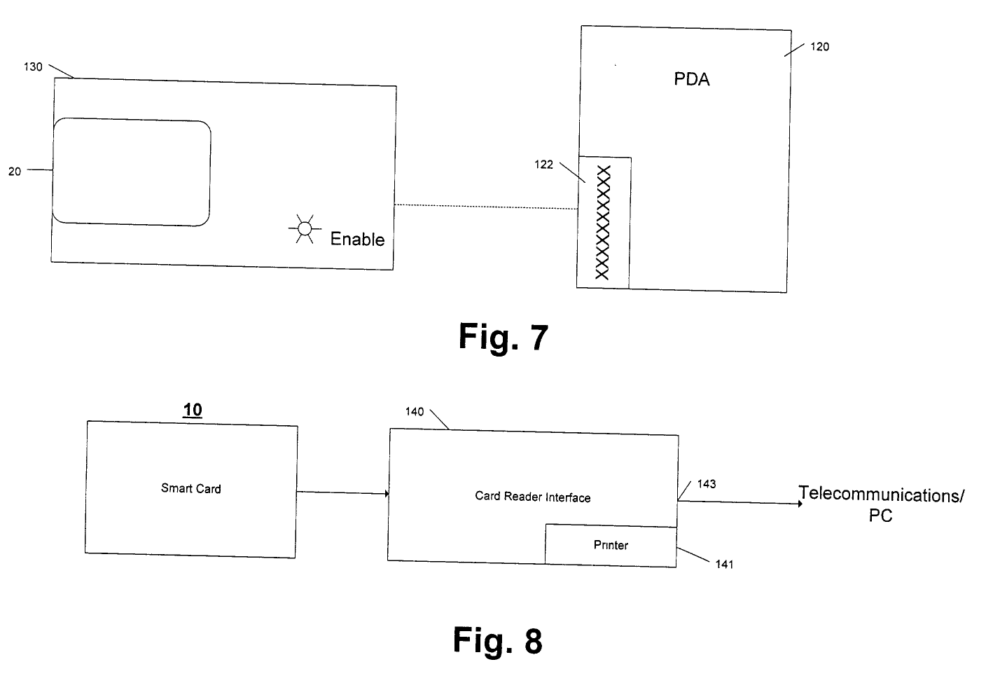

FIG. 7 illustrates a further concept of the invention which takes into account the fact that personal digital assistants (PDAs) have become very popular with an ever increasing segment of the population. Therefore, rather than issuing a fully implemented smart card including all of the electronic circuitry and software, advantage is taken of the fact that PDAs generally can run any software and already have the facilities, including the display and write pad, and other common facilities that are typically found in smart cards.

Thus, the simplified smart card 130 shown in FIG. 7 includes only a fingerprint reader 20 and a store of the personal information to which the scanned information is to be compared. The smart card 130 is interfaced to the card owner's PDA, displaying whether the card presenter is indeed the person to whom the card was issued, and also displaying the personal information in the form of a signature or a photo for inspection by the clerk at the vendor establishment. The clerk can easily test for the possibility that the PDA software has been tampered with by inserting a test card and noting that the PDA is able to carry out all the necessary software steps with respect to the test card. In other respects, the card that is used in conjunction with the card reader interface 140 shown in FIG. 8 accomplishes all the other tasks of the invention.

In accordance with a further concept of the invention, when the smart card of the present invention is enabled, it provides a bar code representation of its identity on its display 24 and that bar code can be then scanned at the vendor establishment by the same wand or bar code reader that is available for scanning merchandise, automatically transmitting the information to the issuing authority and thereby returning a message that indicates whether the card is authentic and also providing approval for the particular transaction. In this manner, the invention dispenses with the dedicated conventional hardware that is used exclusively to read credit cards, etc.

Thus, as described above, and in response to growing threats of terrorism and frequent fraud, the methodology and smart card technology of the present invention provides an answer in the form of a positive and instant identification of persons presenting smart cards for the purpose of engaging in transactions or requiring access to certain spaces or moving through restricted zones, without the need for third party special equipment and/or the need of storing highly sensitive personal information at central information repositories.

The invention further provides its holders ready access to transactional information, such as information about the holder's visits to foreign countries, credit card entries and makes such access instantly available to border control inspectors and the like. The invention aids in increasing security screening of potentially undesirable visitors, as well as implementing other law enforcement functions. As already stressed several times, essential personal identification information and characteristics are stored only on the smart credit card itself and displayed only for limited periods and this information does not appear on any other reading device. The invention relies on the testing of biometric information, such as, for example, fingerprints, eye prints, voice prints, DNA, etc. To assure authenticity and to guard against forgery and alterations, personal information is issued by various central authorities and stored in the card only once, and in a manner such that attempts at alteration produces indicia that would be obvious when the card is presented in its normal course and/or tested for such alteration or forgery.

Although the invention has been described above in relation to particular embodiments thereof, it should be recognized that the invention is applicable to various modifications and alterations, including the testing of any and all biometric information pertaining to a person, including hair, urine, feces, saliva, blood or other human or animal body substance that is indicative of the identity of a person. The transducer 20 can be constructed to recognize any personal characteristics. Several such transducers may be incorporated in a single card to test several biometric parameters. The confirmation signal about the authenticity of the card does not have to be rendered visually, but can also be rendered audibly, for example, by a suitable beeping sequence or the like. A version of the invention limits the alteration of information to the initial creation of the card and results in the voiding of the media and the deletion of personal information upon any attempt to alter the originally stored information.

In accordance with further aspects of the invention, more than one fingerprint may be stored and the person may have the option to use any of the severally stored fingerprints to effect the enablement of the smart card. The display of the invention may consist of a single screen or split screens and the information may be flashed on the screen or scrolled therethrough. Other security measures may be provided as by permanently printing, embossing, laminating or otherwise permanently displaying on the media, personal information. Voice recognition may also be included to validate the smart card.

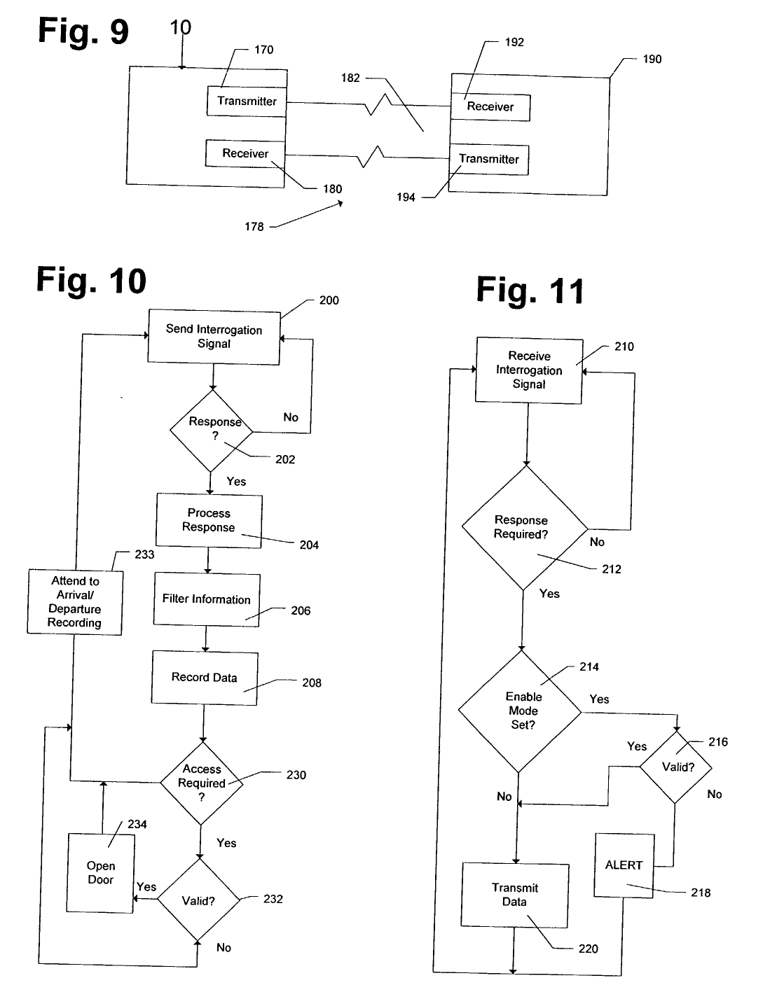

With reference to FIG. 9, the smart cards of the present invention can be used as component parts of an overall personnel tracking and/or as a door access system 178. The system 178 consists of a master or central station or subsystem 190, which is a software and hardware construct that includes a wireless transmitter 194 and a wireless receiver 192. This wireless receiver 192 and wireless transmitter 194 communicate with a plurality of individual transmitters 170 and receivers 180 associated with a plurality of the smart cards 10 of the present invention, communicating wirelessly, as indicated by reference numeral 182.

Functionally, when a bearer of the smart card of the present invention approaches the location of the subsystem 190, the receiver 180 on the smart card detects a continually transmitted interrogating signal that is emitted from the transmitter 194 of the station 190. Responsive thereto, the card transmitter returns a signal identifying the particular card. This triggers the station 190 to take action. The action or response can be in the form of operating a latch to open a normally locked door to allow the card bearer access to an otherwise secured facility. Alternatively, the response consists of identifying the particular card bearer and creating a data record that the card has been detected. When the card bearer arrives at the place of work in the morning and that signal is detected that occurrence may be registered as a time of arrival checking-in event. At the end of the day, the process repeats and a time of departure is recorded, resulting in automatic logging in and out of employees and generating all of the necessary data for paycheck generation, employees' attendance records and the like.

In a well-known manner, the cards 10 operating in conjunction with the station 190 operate in a way that avoids collisions of data transmissions from the plural smart cards. For example, the cards are individually programmed to delay their response, for example, over a period from a fraction of a millisecond, to a thousand milliseconds or to have the delay based on an input from a random number generator to avoid collisions with the responses from other cards. Alternatively, the cards 10 do not respond unless pre-enabled by the user, as by operating the sensory device 20, as heretofore described.

More specifically, and referring to the block diagram of FIG. 10, the step 200 represents the transmission by the subsystem 190 of an interrogation signal. At decision box 202, the subsystem 190 listens and awaits a response from any particular smart card 10. If no response is received within a fraction of a second, another interrogation signal is emitted and the process continues without interruption over time.

However, if a response is received, the process continues to software module 204, where the response is recorded in a computer memory of the subsystem 190. That response is subsequently filtered to distill from it the necessary information at step 206. This information may consist of the identification of the particular card. That information is recorded at step 208, whereupon the program proceeds to decisional box 230, querying whether access to a door is required. If YES, the program proceeds to decisional box 232, asking whether the particular card has been validated by comparing the same to an internal database of valid IDs. If YES, the door is opened by issuing a particular signal to a door latching system (not shown). If access is not required or if the card is not valid, the system proceeds to box 233 to record pertinent further records concerning the given transaction and then the system proceeds in its normal course.

Referring to FIG. 11, at step 210, software resident on the smart card 10 awaits receipt of a interrogation signal from the subsystem 190. At decisional step 212, the determination is made whether such a signal has been received and if YES, the program proceeds to further decisional step 214, querying whether a response should be sent only on the basis that the card has been enabled by its bearer. If the mode has been set accordingly, the program proceeds to decisional box 216 and queries whether in fact the bearer has enabled the card. If YES, the proceeds to step 220, where a response is provided to the subsystem 190 in the form of the identification of the particular card and the program returns to await further signal interrogations at steps 210 and 212. If the card has not been enabled at step 216, the program issues an alert in the form of a visual or audible indication on the card itself. Alternatively, it may send a signal to the subsystem 190, alerting it that the bearer is present but that the card has not been properly enabled, for example, when the person who is carrying the smart card has been determined not to be the rightful or the authorized bearer thereof. Thus, the invention enables an employee check-in and check-out system that operates wirelessly, without any need to place a card directly at or directly adjactent a card sensor. By directly adjacent is meant at a distance of less than eight feet. That is, the invention is able to operate at a distance from the receiver of the master station.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A smart card, comprising:
a housing defining an interior and having an exterior surface;
electronic circuitry in the interior of the housing;
a memory for storing personal data identifying an authorized bearer of the smart card;
a sensor for sensing a personal characteristic of the authorized bearer of the smart card;
a software facility in the smart card for interpreting information received from the sensor and for comparing it against the personal data to verify whether or not the smart card bearer is the authorized bearer of the smart card; and
an indicia facility for providing an indication whether the bearer of the smart card has been authenticated, the smart card being constructed to complete the authentication process without interfacing with any card reader or any external device outside of the smart card.

2. The smart card of claim 1, wherein the personal data comprises the information identifying a personal characteristic of the authorized bearer, wherein the personal characteristics is selected from the group consisting of the likeness of the authorized bearer; the signature of the authorized bearer; an eye pattern of the authorized bearer; the voice of the authorized bearer; a DNA biological signature of the authorized bearer; and the fingerprint of the authorized bearer.

3. The smart card of claim 1, in which the smart card is configured as a card selected from the group consisting of: a credit card; a debit card; a driver's license; a personal identification card; a travel document; an electronic key activating device; and a club membership card.

4. The smart card of claim 1, in which the sensor is selected from a group consisting of: a fingerprint reader; a voice recognition device; a DNA analyzer; a human eye pattern detector; and a signature analyzer.

5. A smart card, comprising:
a housing defining an interior and having an exterior surface;
electronic circuitry housed in the interior of the housing;
a memory for storing personal data identifying an authorized bearer of the smart card;
human perceivable outputs produced by the electronic circuitry for producing functional indications;
a human-activated sensory device accessible at the exterior surface for a human to thereby activate the electronic circuitry to carry out predetermined functional tasks;
a facility for activating the smart card to output, in response to an input from the human-activateable device, a representation of at least a portion of the personal data, as said human perceivable output that is perceivable on the smart card.

6. The smart card of claim 5, wherein the personal data comprises the information identifying a personal characteristic of the authorized bearer, wherein the personal characteristic is selected from the group consisting of: the likeness of the authorized bearer; the signature of the authorized bearer; an eye pattern of the authorized bearer; the voice of the authorized bearer; a DNA signature of the authorized bearer; and the fingerprint of the authorized bearer.

7. The smart card of claim 5, in which the smart card is configured as a card selected from the group consisting of: a credit card; a debit card; a driver's license; a personal identification card; a travel document; an electronic key; and a club membership card.

8. The smart card of claim 5, in which the human-activated sensory device is selected from a group consisting of: a fingerprint reader; a voice recognition device; a DNA analyzer; a human eye pattern detector; and a signature analyzer.

9. The smart card of claim 5, in which the human perceivable output is selected from the group consisting of: a light output; a written message; an audible message; and a circuit enabling signal that allows the smart card to become functional to record a transaction.

10. The smart card of claim 5, in which the smart card includes a conventional magnetic strip that stores card information thereon.

11. The smart card of claim 10, in which the magnetic strip is located on a sheet that is retrievable from within the interior of the smart card.

12. The smart card of claim 3, in which the human-activated sensory device includes a write pad accessible at the exterior surface of the smart card.

13. The smart card of claim 12, including a stylus for writing on the write pad.

14. The smart card of claim 5, including a display and in which the human perceivable output comprises the personal information that is displayed on the display of the smart card.

15. The smart card of claim 5, in which the electronic circuitry includes a CPU, a read-only memory and a read-write memory.

16. The smart card of claim 5, further including an electronic connector for communicating with a reading device.

17. The smart card of claim 5, further including software for enabling interfacing the smart card with the Internet.

18. The smart card of claim 5, further including a facility for receiving an insertible memory card that is insertible into the housing of the smart card to renew the card periodically, the card being a replaceable and exchangeable memory card.

19. The smart card of claim 5, in which the card includes an electronic display.

20. The smart card of claim 5, including a facility for interfacing the card to a reader wirelessly.

21. The smart card of claim 5, in which the card includes a software facility that enables a card issuing agency to communicate electronically therewith and to verify that the card is an authentic card issued by the card issuing agent, without regard to the personal data.

22. The smart card of claim 5, in which the authorized bearer is capable of enabling the card for a predetermined time period.

23. The smart card of claim 22, in which the predetermined time period is programmable.

24. The smart card of claim 5, including a facility that enables creating the smart card remotely by a user operating at a terminal and communicating with an issuing agency and creating the card without any human involvement at the issuing authority side and communicating personal data and the personal data being communicated in encrypted form, so that it is not accessible to anyone at the issuing agency.

25. The smart card of claim 5, including a facility for storing information representing transactions that occur over time and involve the smart card.

26. The smart card of claim 25, including a facility for allowing an authorized bearer to read the contents of various transactions and to provide an output thereof.

27. The smart card of claim 5, including a facility for interfacing the smart card to a personal digital assistant.

28. The smart card of claim 5, including a power source selected from the group consisting of: battery; solar source; light source; kinetic energy and light-operating panel.

29. A smart card system, comprising:
a master system that continuously transmits bearer card interrogation signals via a master transmitter thereof and receives responses via a master receiver thereof;
a plurality of bearer smart cards, each bearer smart card being associated with a corresponding authorized bearer, each smart card including a card receiver for receiving the signals from the master system and a card transmitter that responds thereto in a form of an identification signal, without any need for the smart cards to be placed substantially at or directly adjacent to any physical component of the master system;
a database in the master system identifying valid identification signals; and
a software facility in the master system that triggers a response upon associating a received identification signal with a valid identification signal stored in the database.

30. The smart card of claim 29, in which the response is in the form of a signal that controls a door to become unlocked.

31. The smart card of claim 29, in which the system records data that associates with different bearers of cards a time and date corresponding to detection of the return signal from the particular card.

32. The smart card of claim 31, further including a software facility that determines a time of arrival and a time of departure for corresponding smart cards.

33. The smart card of claim 29, further including an enable circuit on each card and a card including a software facility that causes the card not to respond with a positive identification when the smart card has not been properly enabled by the bearer thereof.

34. The smart card of claim 33, in which the card includes a biometric sensor and the card is enabled only when an authorized bearer has triggered the biometric sensor to issue a valid bearer response.

35. The smart card of claim 29, further including in each card, a facility that delays a response to an interrogation signal by a time delay.

36. The smart card of claim 35, in which the time delay is randomized to avoid collisions with signals received from other cards.
